(19) United States
(12) Patent Application Publication
(10) Pub. No.: US 2009/0126392 A1
(43) Pub. Date: May 21, 2009

(54) Water tank for dispenser and refrigerator having the same

(75) Inventors: Jae Koog An, Gwangju (KR); Jung Rae Kim, Seoul (KR); Jong Yeob Kim, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/230,701

(22) Filed: Sep. 3, 2008

(30) Foreign Application Priority Data
Nov. 20, 2007 (KR) 10-2007-0118410

(51) Int. Cl. B67D 5/62; B67D 5/58; B65D 51/16

(52) U.S. Cl. 62/389; 222/189.06; 220/361

(57) ABSTRACT

A water tank for a dispenser capable of improving convenience when the user injects water into the water tank and a refrigerator having the same are disclosed. The water tank for a dispenser includes a reservoir which stores water and has an opening, a cover which covers the opening and has an injection port to inject water into the reservoir, and an opening/closing unit which opens and closes the injection port, the opening/closing unit being operated by loading of water above and into the injection port to open the injection port.

### CROSS-REFERENCE TO RELATED APPLICATIONS

This application claims the benefit of Korean Patent Application No. 2007-0118410, filed on Nov. 20, 2007 in the Korean Intellectual Property Office, the disclosure of which is incorporated herein by reference.

### BACKGROUND

1. Field

The present invention relates to a water tank for a dispenser and a refrigerator having the same, and, more particularly, to a water tank for a dispenser capable of facilitating water supply and offering improved usability to a user and a refrigerator having the same.

2. Description of the Related Art

Generally, a water dispenser is an apparatus which automatically distributes drinking water. The dispenser is installed at home or office, or in a public place for home or commercial use. The dispenser may be connected to a water supply or the like to supply drinking water to the user, or may include a water container to supply water of the water container to the user.

The dispenser may be provided as an individual device, or may be coupled to other electric home appliances. As an example of an electric home appliance having the dispenser, there is a refrigerator having the dispenser, and recently, refrigerators having various configurations are being developed.

FIG. 1 illustrates a perspective view showing essential parts of a conventional refrigerator having a dispenser.

As shown in FIG. 1, the conventional refrigerator having the dispenser includes a storage compartment (not shown) which stores various foodstuffs in a frozen or cooled state, a door 1 which opens and closes the storage compartment, a dispenser 2 which is disposed on the door 1 to supply drinking water to the user, and a water tank 3 which is disposed on the inside of the door 1 to be connected to the dispenser 2.

An injection port 4 is formed on an upper surface of the water tank 3. A cover 5 is disposed at the injection port 4 to open and close the injection port 4.

Accordingly, after the user opens the cover 5 to open the injection port 4, the user fills the water tank 5 with drinking water and stores the water tank 5 in a cooling compartment. When necessary, the user can use water in the water tank 3 through the dispenser 2 formed on the door 1 without opening the door 1.

However, in the conventional water tank for a dispenser and the conventional refrigerator having the water tank, when the user intends to inject water into the water tank, the user should detach the water tank from the storage compartment and open the cover to inject water into the water tank, or should open the cover and use an additional container to inject water into the water tank while the water tank is fixed to the storage compartment. Thus, there is a problem of reducing convenience of the user.

### SUMMARY

The present embodiment has been made in order to solve the above problems. It is an aspect of the embodiment to provide a water tank for a dispenser and a refrigerator having the same capable of improving convenience when a user injects water into the water tank.

It is another aspect of the embodiment to provide a refrigerator capable of minimizing cold loss by injecting water into a water tank for a short period of time when water is injected into the water tank while the water tank is fixed to a storage compartment.

Additional aspects and/or advantages will be set forth in part in the description which follows and, in part, will be obvious from the description, or may be learned by practice of the invention.

The foregoing and/or other aspects are achieved by providing a water tank for a dispenser, including: a reservoir configured to store water and having an opening; a cover covering the opening and having an injection port to inject water into the reservoir; and an opening/closing unit opening and closing the injection port, the opening/closing unit being operated by loading of water above and into the injection port to open the injection port.

The opening/closing unit may include an opening/closing portion corresponding to the injection port to open and close the injection port, and a rotation shaft rotatably fixing the opening/closing portion on the cover.

The opening/closing unit may be rotated downward by a load pressing an upper surface of the opening/closing portion to open the injection port, and the opening/closing unit may be rotated upward to close the injection port when the load pressing the upper surface of the opening/closing portion is removed.

The opening/closing unit may further include a weight portion disposed opposite to the opening/closing portion, the opening/closing portion and the weight portion performing a seesaw motion according to a force applied to the opening/closing portion.

The opening/closing unit may further include at least one resilient member providing an elastic force such that the opening/closing portion is maintained to close the injection port.

The cover may further include an inclined portion guiding water toward the injection port.

The reservoir may further include a filter to purify water and an auxiliary container on which the filter is mounted and which sectionalizes a space of the reservoir.

The cover may further include a handle disposed at an upper portion of the inclined portion.

The reservoir may further include a valve to intermittently discharge water.

The foregoing and/or other aspects are achieved by providing a water tank for a dispenser, including: an injection port through which water is injected; a reservoir storing the injected water; and an opening/closing unit opening and closing the injection port according to a load of water applied to the injection port.

The foregoing and/or other aspects are achieved by providing a refrigerator, including: a storage compartment to store food to be cooled; a water tank disposed in the storage compartment, the water tank including an injection port through which water is injected, a reservoir storing the injected water, and an opening/closing unit opening and closing the injection port, the opening/closing unit being operated by loading of the water above and into the injection port to open the injection port; and a dispenser discharging water from the water tank to an outside.

The water tank may further include an inclined portion guiding water toward the injection port.

The water tank may further include a handle disposed at an upper portion of the inclined portion.

The water tank may include a cover, and the opening/closing unit may include an opening/closing portion corresponding to the injection port to open and close the injection port, a rotation shaft rotatably fixing the opening/closing portion on the cover, and a weight portion disposed opposite to the opening/closing portion, the opening/closing portion and the weight portion performing a seesaw motion according to a load applied to the opening/closing portion.

The water tank may include a cover, and the opening/closing unit may include an opening/closing portion corresponding to the injection port to open and close the injection port, a rotation shaft rotatably fixing the opening/closing portion on the cover, and a resilient member providing an elastic force such that the opening/closing portion is maintained to close the injection port.

The foregoing and/or other aspects are achieved by providing a water tank for a dispenser of a refrigerator, including: a reservoir configured to store water; a cover covering the reservoir and including an injection port into which water is injected to enter the reservoir; and an opening/closing unit disposed beneath and adjacent to the injection port and opening and closing the injection port, the opening/closing unit maintaining the injection port in a closed state until water is injected through the injection port.

The opening/closing unit may include an opening/closing portion opening and closing the injection port and a weight portion opposite the opening/closing portion to maintain the injection port in the closed state.

The opening/closing unit may include an opening/closing portion opening and closing the injection port and at least one resilient member to maintain the injection port in the close state.

The water tank for a dispenser and the refrigerator having the same according to the present embodiments include an opening/closing unit which is disposed at an inlet side to automatically open and close the inlet according to an applied load such that the user can inject water into the water tank without manually opening the inlet, thereby improving convenience of the user.

Further, when the user injects water into the water tank while the water tank is fixed to the storage compartment, the inlet can be opened along with the injection of water without manually opening the inlet. Thus, it is possible to inject water for a short period of time, thereby shortening a door opening time. There is an effect of minimizing cold loss.

### BRIEF DESCRIPTION OF THE DRAWINGS

These and/or other aspects and advantages will become apparent and more readily appreciated from the following description of the embodiments, taken in conjunction with the accompanying drawings, of which:

FIG. 1 illustrates a perspective view showing essential parts of a conventional refrigerator having a dispenser;

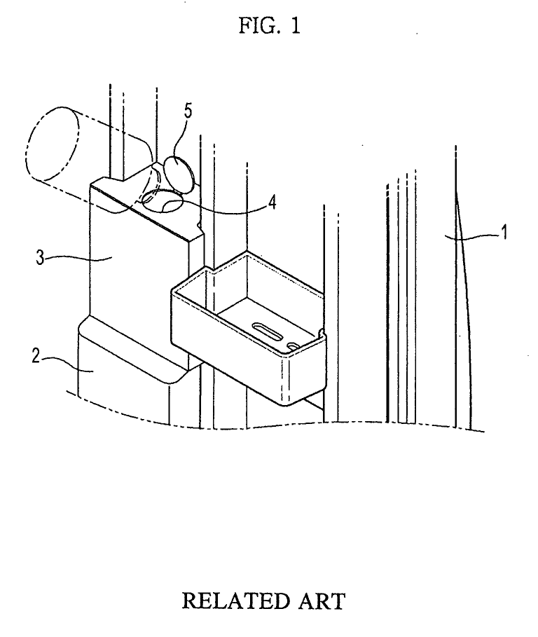

FIG. 2 illustrates a perspective view of a water tank for a dispenser and a refrigerator having the same according to an embodiment;

FIG. 3 illustrates a cross-sectional view of the dispenser and the water tank shown in FIG. 2;

FIG. 4 illustrates a perspective view of the water tank for a dispenser according to the embodiment;

FIG. 5 illustrates an exploded perspective view of FIG. 4;

FIG. 6 illustrates an operational view of the water tank for a dispenser according to the embodiment; and

FIG. 7 illustrates a perspective view showing a modified embodiment of an opening/closing unit of the water tank.

### DETAILED DESCRIPTION OF EMBODIMENTS

Reference will now be made in detail to the embodiments, examples of which are illustrated in the accompanying drawings, wherein like reference numerals refer to like elements throughout. The embodiments are described below to explain the present invention by referring to the figures.

Hereinafter, embodiments will be described in detail with reference to the accompanying drawings.

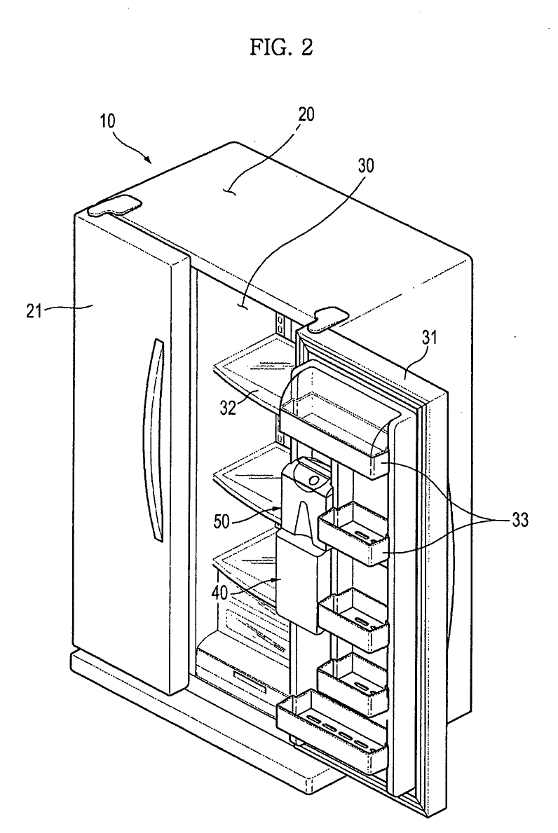

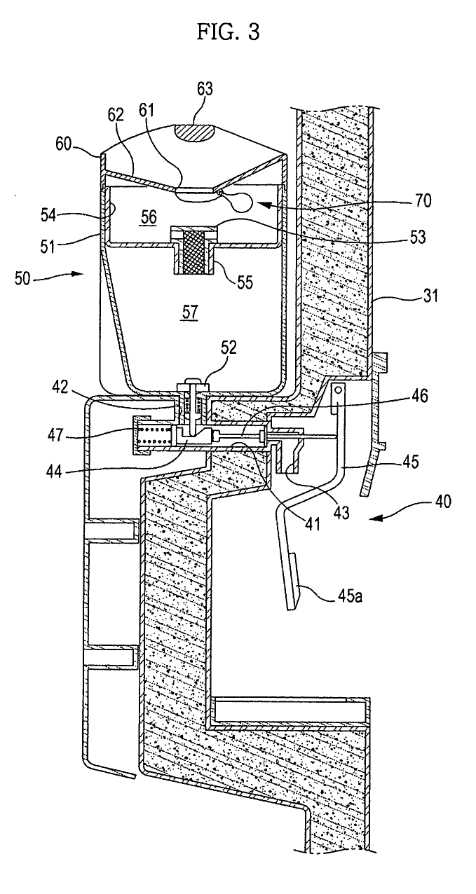

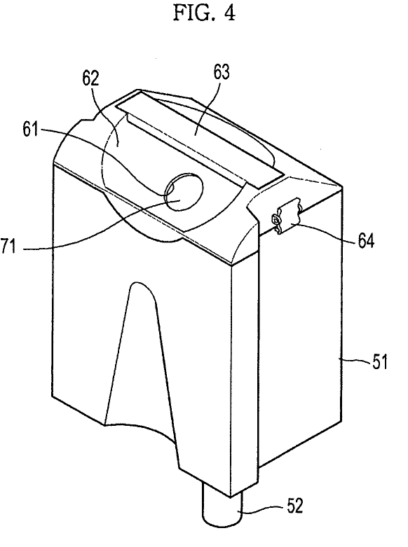

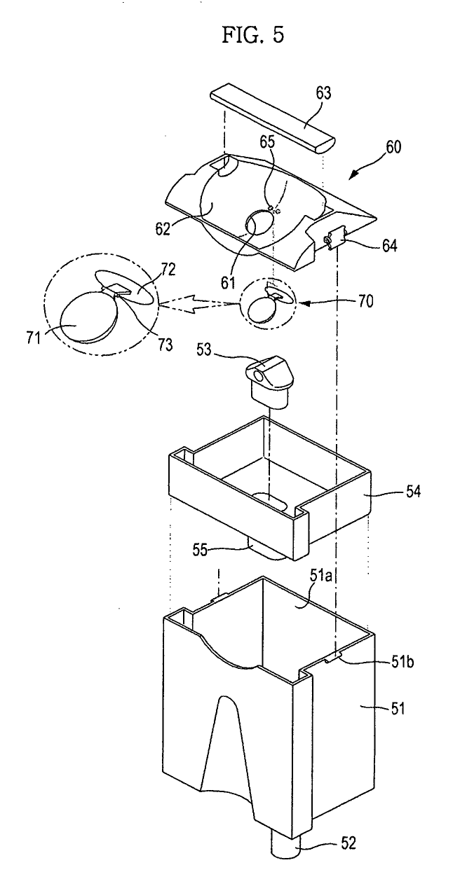

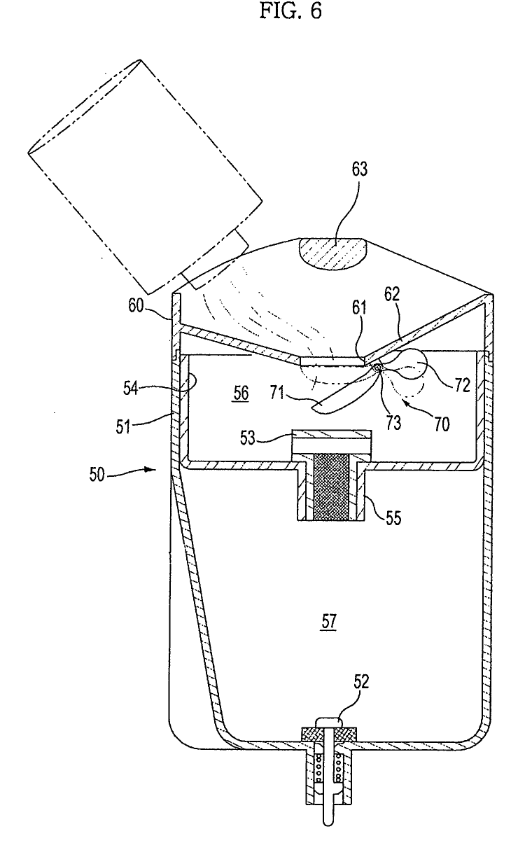

FIG. 2 illustrates a perspective view of a water tank for a dispenser and a refrigerator having the same according to an embodiment. FIG. 3 illustrates a cross-sectional view of the dispenser and the water tank shown in FIG. 2. FIG. 4 illustrates a perspective view of the water tank for a dispenser according to the embodiment. FIG. 5 illustrates an exploded perspective view of FIG. 4. FIG. 6 illustrates an operational view of the water tank for a dispenser according to the embodiment.

As shown in FIG. 2, the refrigerator according to the present embodiment includes a main body 10 with an open front surface, which has storage compartments 20 and 30. The storage compartments 20 and 30 in the main body 10 include a first storage compartment 20 and a second storage compartment 30 which are defined on the left and right, respectively, by an intermediate wall. A first storage compartment door 21 and a second storage compartment door 31 are installed on the front surface of the main body 10 to open and close the first storage compartment 20 and the second storage compartment 30, respectively.

In this embodiment, the first storage compartment is used as a freezing compartment and the second storage compartment is used as a cooling compartment. However, the first storage compartment may be used as a cooling compartment and the second storage compartment may be used as a freezing compartment. Further, according to the selection of the user, both the storage compartments may be used as a freezing compartment or a cooling compartment. For this, the temperature in the storage compartments can be controlled.

The main body 10 is formed in a box shape filled with a urethane foam thermal insulator. A machine room (not shown), equipped with various electric and electronic devices, is formed at a lower rear portion of the main body 10. In the same way as in a conventional general refrigerator, a compressor (not shown) of a refrigeration cycle, a condenser (not shown) which condenses a high-temperature, high-pressure coolant discharged from the compressor (not shown) and an electronic box (not shown) and the like are installed in the machine room.

One or more shelves 32 may be installed in the second storage compartment 30 to place stored articles thereon. The shelves 32 are guided by guides (not shown) formed on sidewalls of the second storage compartment 30 to be inserted and fixed to the second storage compartment 30.

A plurality of shelves 32 may be vertically installed at specific intervals according to the size of a storage space to sectionalize the storage space, thereby storing more stored articles.

One side of the second storage compartment door 31 is hinge-coupled to the second storage compartment 30 to open and close the second storage compartment 30. A plurality of receiving portions 33 may be formed on the inside of the second storage compartment door 31. As shown in FIG. 3, a water tank 50 having a valve 52 is detachably fixed to the second storage compartment door 31 to supply water to a dispenser 40. Further, the dispenser 40 is disposed below the water tank 50 to intermittently discharge water of the water tank 50 without opening the second storage compartment door 31.

The dispenser 40 includes a water supply cylinder 41 which is installed to pass through the second storage compartment door 31, a piston 44 which is slidably installed in the water supply cylinder 41, and a lever 45 which drives the piston 44.

The water supply cylinder 41 includes an inlet 42 which is coupled to the valve 52 of the water tank 50 and an outlet 43 which discharges water that has passed through the water supply cylinder 41 to the outside.

The piston 44 slides in the water supply cylinder 41 to open and close the valve 52 of the water tank 50. A pressing portion 46, which transfers a rotational force of the lever 45 to the piston 44 to slide the piston 44, is disposed at one end portion of the piston 44. A resilient spring 47, which exerts an elastic force to restore the piston 44 when a force applied to the lever 45 is removed, is disposed at the other end portion of the piston 44.

The lever 45 is pressed by the user to discharge water. The upper side of the lever 45 is rotatably hinge-coupled to the door. A push portion 45a of a specific size is formed at the lower side of the lever 45 to be pressed by the user with a cup or the like.

Accordingly, when the user operates the lever 45 with a cup or the like, the pressing portion 46 moves the piston 44 backward in the water supply cylinder 41. At the same time, the piston 44 opens the valve 52, thereby discharging water of the water tank 50 to the front surface of the second storage compartment door 31 through the water supply cylinder 41 and the outlet 43.

Further, when the force applied to the lever 45 is removed, the piston 44 is restored to close the valve 52 by an elastic force of the resilient spring 47 which is interposed between the rear surface of the piston 44 and the water supply cylinder 41.

The above mechanical configuration in which the lever is used to discharge water of the water tank may be replaced by a configuration in which a switch is provided instead of the lever to turn on/off the valve by an electric signal according to on/off of the switch.

As shown in FIGS. 3 to 5, the water tank 50 includes a reservoir 51 having an accommodation space in which water is stored, the valve 52 which is disposed on the reservoir 51 to discharge water of the water tank 50 to the outside by interworking with the lever 45, a cover 60 which closes an upper portion of the reservoir 51 and on which an injection port 61 is formed to inject water into the reservoir 51, and an opening/closing unit 70 which opens and closes the injection port 61.

An opening 51a is formed at the upper portion of the reservoir 51, and the reservoir 51 is formed to have a specific water storage capacity. In case that the reservoir 51 is mounted on the rear surface of the second storage compartment door 31, the thickness, height and width of the reservoir 51 can be adjusted to prevent the reservoir 51 from being excessively protruded toward the second storage compartment 30.

Further, the reservoir 51 may include a filter 53 which purifies the injected water and discharges the purified water to the dispenser 40 and an auxiliary container 54 which fixes the filter 53 and defines first and second reservoir portions 56 and 57 in the reservoir 51.

The filter 53 may employ a general filter manufactured by Brita™ (Germany), for example, or may employ various types of filters, each being manufactured as a single product, to purify water.

The auxiliary container 54 is formed to have a specific size and is mounted on the upper portion of the reservoir 51. A filter fixing portion 55 is formed at the center of the auxiliary container 54 to fix the filter 53.

Accordingly, water introduced into the reservoir 51 through the injection port 61 flows into the first reservoir portion 56 defined by the auxiliary container 54. Then, the water is purified while passing through the filter 53 and is stored in the second reservoir portion 57.

The cover 60 is detachably disposed at the opening 51a of the reservoir 51.

The cover 60 includes the injection port 61 which is formed at approximately the center of the cover 60 such that the user can inject water into the reservoir 51, and an inclined portion 62 which is inclined downward from the outside toward the injection port 61 such that the water injected by the user is guided toward the injection port 61 without overflowing the water tank 50.

Further, the cover 60 may include a handle 63 for the user to conveniently attach or detach the water tank 50 to or from the rear surface of the second storage compartment door 31.

In this case, the handle 63 is formed to connect upper end portions of the inclined portion 62. Accordingly, it is possible to easily inject water into the reservoir 51 using the inclined portion 62. Also, when the user lifts up the water tank 50, the user can hold the handle 63 by putting his hand into a space formed between the inclined portion 62 recessed downward and the handle 53, thereby improving space efficiency.

Further, in order to prevent the cover 60 from being separated from the reservoir 51 when the user moves the water tank 50 while holding the handle 63, a pair of hooks 64 is provided at opposite sides of the boundary of the cover 60 and a pair of hook fixing portions 51b is provided on the reservoir 51 corresponding to the hooks 64. While a pair of hooks 64 and corresponding hook fixing portions 51b are provided to maintain the cover 60 in contact with the reservoir 51, any other type of non-permanent attachment mechanism may be used to affix the cover 60 to the reservoir 51.

The handle 63 and the cover 60 may be formed as a single body through injection molding. However, in this embodiment, the handle 63 is firmly coupled to the cover 60 using screws.

In the present embodiment, the opening/closing unit 70 is provided to open and close the injection port 61. The opening/closing unit 70 includes an opening/closing portion 71 corresponding to the injection port 61 to open and close the injection port 61, a weight portion 72 which is positioned opposite to the opening/closing portion 71 to support the opening/closing portion 71 upward, and a rotation shaft 73 provided such that the opening/closing unit 70 is fixed to perform a seesaw motion on the rear surface of the cover 60.

The opening/closing portion 71 is formed to be somewhat larger than the size of the injection port 61 to close the injection port 61.

The weight portion 72 is somewhat heavier than the weight of the opening/closing portion 71 to move downward, while moving the opening/closing portion 71 upward, when the rotation shaft 73 is fixed to the rear surface of the cover 60.

The rotation shaft 73 is disposed between the opening/closing portion 71 and the weight portion 72 and is inserted into a shaft fixing portion 65 formed on the rear surface of the cover 60 such that the opening/closing portion 71 and the weight portion 72 can perform a seesaw motion.

Since the weight portion 72 has a weight larger than the weight of the opening/closing portion 71, as shown in FIG. 6, when an external force is not exerted, the opening/closing portion 71 performs a seesaw motion to move upward due to the weight of the weight portion 72. Accordingly, an upper boundary portion of the opening/closing portion 71 is in contact with a lower boundary portion of the injection port 61 such that the opening/closing portion 71 closes the injection port 61.

In this case, when the user pours water onto the inclined portion 62 to inject water into the injection port 61, the poured water is guided toward the injection port 61 along the inclined portion 62. The opening/closing portion 71 is moved downward due to the weight of the water guided to above the injection port 61. At the same time, the weight portion 72 performs a seesaw motion to move upward. Accordingly, the opening/closing portion 71 opens the injection port 61 such that the user can inject water into the water tank 50 through the injection port 61.

Then, when a load pressing the upper surface of the opening/closing portion 71 is removed as the injection of water is finished, the weight portion 72, which is relatively heavier than the opening/closing portion 71, is moved downward. At the same time, the opening/closing portion 71 performs a seesaw motion to move upward, thereby closing the injection port 61.

Thus, the opening/closing portion can open and close the injection port along with the injection of water without an additional driving device. That is, since the injection port can be opened only when water is injected, it is possible to prevent foreign matter from entering the water tank.

Further, although the filter is disposed in the main body in the embodiment, the present embodiment is not limited thereto. That is, the filter and a partition member may be removed and purified water may be directly injected into the main body such that the user can use drinking water which is discharged from the dispenser.

Next, a modified embodiment of the opening/closing unit included in the water tank will be explained.

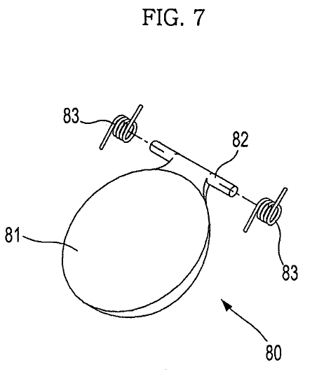

FIG. 7 illustrates a perspective view showing a modified embodiment of the opening/closing unit of the water tank.

The modified embodiment has the same configuration as the above embodiment except that they are different in the opening/closing unit.

The opening/closing unit of the water tank according to the modified embodiment includes an opening/closing unit 80 to open and close the injection port 61. The opening/closing unit 80 includes an opening/closing portion 81 corresponding to the injection port 61 to open and close the injection port 61, a rotation shaft 82 provided to rotatably fix the opening/closing portion 81 on the rear surface of the cover, and resilient members 83 which are disposed at the rotation shaft 82 to provide an elastic force such that the opening/closing portion 81 is maintained to close the injection port 61 when an external force is not exerted.

The resilient members 83 may be torsion springs, for example, which are fixed to the rotation shaft 82, but may be any type of resilient, flexible member that is able to restore a force applied thereto One end of each of the resilient members 83 is supported by the lower surface of the opening/closing portion 81 and the other end of each of the resilient members 83 is supported by the rear surface of the cover 60.

In this case, the elastic force of the resilient members 83 may be appropriately set such that the opening/closing portion 81 can open the injection port 61 by water poured onto the injection port 60.

Accordingly, when the user pours water to the inclined portion 62 to inject water into the injection port 61, the poured water is guided toward the injection port 61 along the inclined portion 62. The resilient members 83 are elastically deformed to rotate the opening/closing portion 81 downward due to the weight of the water guided to above the injection port 61, thereby opening the injection port 61.

Then, when a load pressing the upper surface of the opening/closing portion 81 is removed as the injection of water is finished, the opening/closing portion 81 is rotated upward by an elastic restoration force of the resilient members 83, thereby closing the injection port 61.

Although the water tank is applied to the refrigerator in the above embodiments, the water tank is not limited thereto. For example, the water tank according to the present embodiments may be applied to a separate dispenser.

Although embodiments have been shown and described, it would be appreciated by those skilled in the art that changes may be made in these embodiments without departing from the principles and spirit of the invention, the scope of which is defined in the claims and their equivalents.

What is claimed is:

1. A water tank for a dispenser, comprising:
a reservoir configured to store water and having an opening;
a cover covering the opening and having an injection port to inject water into the reservoir; and
an opening/closing unit opening and closing the injection port, the opening/closing unit being operated by loading of water above and into the injection port to open the injection port.

2. The water tank according to claim 1, wherein the opening/closing unit includes an opening/closing portion corresponding to the injection port to open and close the injection port, and a rotation shaft rotatably fixing the opening/closing portion on the cover.

3. The water tank according to claim 2, wherein the opening/closing unit is rotated downward by a load pressing an upper surface of the opening/closing portion to open the injection port, and the opening/closing unit is rotated upward to close the injection port when the load pressing the upper surface of the opening/closing portion is removed.

4. The water tank according to claim 2, wherein the opening/closing unit further includes a weight portion disposed opposite to the opening/closing portion, the opening/closing portion and the weight portion performing a seesaw motion according to a force applied to the opening/closing portion.

5. The water tank according to claim 2, wherein the opening/closing unit further includes at least one resilient member providing an elastic force such that the opening/closing portion is maintained to close the injection port.

6. The water tank according to claim 1, wherein the cover further includes an inclined portion guiding water toward the injection port.

7. The water tank according to claim 1, wherein the reservoir further includes a filter to purify the water and an auxiliary container on which the filter is mounted and which sectionalizes a space of the reservoir.

8. The water tank according to claim 6, wherein the cover further includes a handle disposed at an upper portion of the inclined portion.

9. The water tank according to claim 1, wherein the reservoir further includes a valve to intermittently discharge water.

10. A water tank for a dispenser, comprising:
an injection port through which water is injected;
a reservoir storing the injected water; and
an opening/closing unit opening and closing the injection port according to a load of water applied to the injection port.

11. A refrigerator, comprising:
a storage compartment to store food to be cooled;
a water tank disposed in the storage compartment, the water tank including an injection port through which water is injected, a reservoir storing the injected water, and an opening/closing unit opening and closing the injection port, the opening/closing unit being operated by loading of the water above and into the injection port to open the injection port; and
a dispenser discharging water from the water tank to an outside.

12. The refrigerator according to claim 11, wherein the water tank further includes an inclined portion guiding water toward the injection port.

13. The refrigerator according to claim 12, wherein the water tank further includes a handle disposed at an upper portion of the inclined portion.

14. The refrigerator according to claim 11, wherein the water tank includes a cover, and the opening/closing unit includes an opening/closing portion corresponding to the injection port to open and close the injection port, a rotation shaft rotatably fixing the opening/closing portion on the cover, and a weight portion disposed opposite to the opening/closing portion, the opening/closing portion and the weight portion performing a seesaw motion according to a load applied to the opening/closing portion.

15. The refrigerator according to claim 11, wherein the water tank includes a cover, and the opening/closing unit includes an opening/closing portion corresponding to the injection port to open and close the injection port, a rotation shaft rotatably fixing the opening/closing portion on the cover, and a resilient member providing an elastic force such that the opening/closing portion is maintained to close the injection port.

16. A water tank for a dispenser of a refrigerator, comprising:
a reservoir configured to store water;
a cover covering the reservoir and including an injection port into which water is injected to enter the reservoir; and
an opening/closing unit disposed beneath and adjacent to the injection port and opening and closing the injection port, the opening/closing unit maintaining the injection port in a closed state until water is injected through the injection port.

17. The water tank according to claim 16, wherein the opening/closing unit includes an opening/closing portion opening and closing the injection port and a weight portion opposite the opening/closing portion to maintain the injection port in the closed state.

18. The water tank according to claim 16, wherein the opening/closing unit includes an opening/closing portion opening and closing the injection port and at least one resilient member to maintain the injection port in the close state.
